(19) United States
(12) Patent Application Publication
(10) Pub. No.: US 2026/0236075 A1
(43) Pub. Date: Aug. 13, 2026

(54) Peak-Current Draw Mitigation

(71) Applicant: Google LLC, Mountain View, CA (US)

(72) Inventors: Ravindhiran Mukundrajan, Bangalore (IN); Sanjeev Suresh, Campbell, CA (US); James Christian Salvia, Belmont, CA (US); Inapakurti Srikanth, Bengaluru (IN); Martin Johannes Kraemer, Mountain View, CA (US); Mohsen Heidarinejad, San Jose, CA (US); Vinu Vijay Kumar, Belmont, CA (US); Druthi Umapathy, Santa Clara, CA (US)

(73) Assignee: Google LLC, Mountain View, CA (US)

(21) Appl. No.: 19/049,371

(22) Filed: Feb. 10, 2025

(51) Int. Cl. G06F 1/26

(52) U.S. Cl. CPC G06F 1/26

(57) ABSTRACT

The present document describes techniques associated with peak-current draw mitigation. These techniques utilize on-die components (e.g., current sensor and a frequency-locked loop (FLL)) of a system-on-chip (SoC) to provide a precise mitigation strategy for current draw with minimal degradation in performance. In particular, the mitigation techniques described herein include a power-regulating circuitry that ensures that the peak current drawn by the SoC intellectual property (IP) cores does not exceed the rated capacity of the power supply, while also ensuring that impact on computing throughput is both graceful and gradual, thereby avoiding an abrupt and/or visible degradation in user experience. In aspects, the power-regulating circuitry incrementally decreases its output frequency by a pre-programmed amount (e.g., 10%) to decrease the power draw by a corresponding amount until the current draw is below a threshold, in contrast to conventional frequency dividers that significantly drop the current by 50% or more.

### BACKGROUND

On battery-operated smart devices (e.g., a mobile phone), the amount of power that can be supplied to the device's System-on-Chip (SoC), where tasks are executed, is constrained. Such constraint is due to limitations in the battery pack, power-regulation circuitry, thermal constraints, and the like. When an intellectual property core (IP core) within the SoC draws more power (e.g., more current at a fixed output voltage) than what is supported, the voltage drops, resulting in what is known as a “Brownout.” A Brownout is a sudden momentary power loss (SMPL), which can lead to user-perceptible and/or visible degradation in performance and a poor user experience. For example, the Brownout can result in a frozen display, dropped frames, a device shutdown, and the like. The constant advancements in computer software continue to increase workload concurrency, which can push existing systems to their limits and significantly increase the probability of a Brownout.

The various IP cores in an SoC are powered by switching regulators present in a corresponding Power Management Integrated Circuit (PMIC). Each switching regulator (also known as Switched Mode Power Supply (SMPS)) has a certain rated current output across a range of output voltages. When a sustained current draw is beyond a rated capacity of the regulator, the output voltage of the regulator starts to drop and causes the circuits in the SoC to fail operationally, causing a Brownout. In conventional systems, the PMIC triggers early warning messages to the SoC when certain predetermined current threshold levels are breached. The SoC leverages these warning messages to initiate appropriate throttling mechanisms to ensure that the IP core operates within rated limits. However, when the sustained current draw is over the rated limit of the regulator, it triggers a system reset, shutting down the device and resulting in a poor user experience.

To prevent Brownouts from occurring, SoCs typically employ one or more mitigation mechanisms. Conventional mitigation techniques for current overdraw typically implement frequency dividers (f/2, f/4, or f/8) on the clocks to throttle circuit switching activity in the same ratio of the divider, thus leading to a lower current draw from the PMIC. This conventional approach, however, also results in significant performance degradation (e.g., display freeze, dropped frames), which can be perceived by the end user. Further, scaling the clock frequency by a factor of two or more creates an abrupt change in power draw, which can result in undesirable transients on the power distribution network (e.g., voltage overshoot or undershoot events) when the mitigation is engaged or disengaged.

### SUMMARY

The present document describes techniques associated with peak-current draw mitigation. These techniques utilize on-die components (e.g., current sensor and a frequency-locked loop (FLL)) of a system-on-chip (SoC) to provide a precise mitigation strategy for current draw with minimal degradation in performance. In particular, the mitigation techniques described herein include power-regulating circuitry that ensures that the peak current drawn by the SoC IP cores does not exceed the rated capacity of the power supply, while also ensuring that impact on computing throughput is both graceful and gradual, thereby avoiding an abrupt and/or visible degradation in user experience. In aspects, the power-regulating circuitry incrementally decreases its output frequency by a pre-programmed amount (e.g., 5%, 10%) to decrease the power draw by a corresponding amount until the current draw is below a threshold, in contrast to conventional frequency dividers that significantly drop the current by 50% or more.

In an example, a system-on-chip for mitigating peak-current draw is disclosed. The system-on-chip includes a sub-system and power-regulating circuitry integrated with the sub-system. The sub-system includes an intellectual property (IP) core. The power-regulating circuitry includes a frequency-locked loop (FLL) configured to generate an output frequency and automatically adjust the output frequency over a duration of time to recover the output frequency to a multiple of a reference frequency. The power-regulating circuitry also includes a current sensor configured to periodically sample a rail current drawn by the IP core. In aspects, the power-regulating circuitry is configured to generate, in response to a current sample of the rail current exceeding a current threshold, a step-down trigger configured to cause the FLL to modulate the output frequency by a predetermined amount to reduce the rail current drawn by the IP core.

In an example, a method for peak-current draw mitigation is disclosed. The method includes periodically sampling, using an on-die current sensor, a rail current drawn by an IP core of a sub-system of a system-on-chip. The method also includes comparing a current sample of the rail current against a programmed threshold. Further, the method includes determining whether the current sample of the rail current exceeds the programmed threshold. In addition, the method includes, in response to a determination that the current sample of the rail current exceeds the programmed threshold, modulating an output frequency of a frequency-locked loop (FLL) to decrease the rail current drawn by the IP core.

This summary is provided to introduce simplified concepts of peak-current draw mitigation, which are further described below in the Detailed Description. This summary is not intended to identify essential features of the claimed subject matter, nor is it intended for use in determining the scope of the claimed subject matter.

### BRIEF DESCRIPTION OF DRAWINGS

The details of one or more aspects of peak-current draw mitigation are described in this document with reference to the following drawings. The same numbers are used throughout the drawings to reference like features and components:

FIG. 1 illustrates an example environment that includes an electronic device in which aspects of peak-current draw mitigation can be implemented;

FIG. 2 illustrates an example implementation of the electronic device from FIG. 1 in more detail;

FIG. 3 illustrates an example configuration of the power-regulating circuitry from FIG. 2 in more detail and in accordance with some implementations;

FIG. 4 illustrates an example configuration of the frequency-locked loop from FIG. 3;

FIG. 5 illustrates an example implementation of peak-current mitigation techniques described herein in comparison to conventional mitigation techniques;

FIG. 6 illustrates another example implementation of peak-current mitigation techniques described herein in comparison to conventional mitigation techniques;

FIG. 7 illustrates a block diagram of an example SoC stack in accordance with some implementations;

FIG. 8 depicts a method for implementing peak-current draw mitigation; and

FIG. 9 illustrates an example system-on-chip (SoC) in which aspects of peak-current draw mitigation can be implemented.

### DETAILED DESCRIPTION

### Overview

An IP core within a System-on-Chip (SoC) that draws more power (e.g., more current at a fixed output voltage) than what is supported causes a voltage drop and results in what is known as a “Brownout,” which is a sudden momentary power loss (SMPL). A Brownout can lead to user-perceptible and/or visible degradation in performance and a poor user experience. To significantly reduce the risk of a Brownout occurring, the techniques described herein leverage a current sensor and a frequency-locked loop (FLL) of the SoC to provide a precise mitigation strategy with minimal degradation in performance.

The FLL is an electronic control system that generates a signal that is “locked” to the frequency of an input or reference signal, referred to as a reference frequency. This FLL circuit compares the frequency of a digitally controlled oscillator to the reference signal, automatically adjusting (e.g., increasing, decreasing) the frequency of the oscillator until its frequency (but not necessarily its phase) is matched to a multiple (e.g., integer multiple) of that of the reference signal. The FLL can be used as a clock source for at least some of the IP cores in the SoC. The FLL provides an output frequency (from the oscillator) and, in aspects, can modulate that output frequency automatically in response to fast transient noise fluctuations in voltage supply levels. The FLL can further ensure that SoC operation is not affected by such noise fluctuations.

The current sensor can be integrated with an IP core of the SoC. The current sensor is configured to measure current drawn by the SoC IP core over specified intervals. In one example, the current sensor measures electric current drawn by the IP core and provides data usable to tune one or more algorithms implemented by a power management framework of the SoC, such as an On-die Power Management (ODPM) framework. The ODPM framework refers to a system where the circuitry responsible for regulating and controlling power consumption within an integrated circuit (IC) is directly integrated onto the same silicon die as the other logic circuits, enabling more precise and efficient power management compared to using separate, external power-management components.

The mitigation techniques described herein include power-regulating circuitry that ensures that the peak current drawn by the SoC IP cores does not exceed the rated capacity of the Switched Mode Power Supply (SMPS)), while also ensuring that impact on computing throughput is both graceful and gradual. This in turn ensures that the end user does not encounter an abrupt and/or visible degradation in the user experience.

The on-die current sensor monitors the current drawn by an IP subsystem over a predetermined period of time and triggers an interrupt in response to a sustained current draw being greater than the rated current limit of the SMPS. Thus, an expeditious advanced warning can be generated within the SoC itself and mitigation actions can be initiated immediately in a phased manner. Such techniques avoid the conventional reliance on PMIC warning messages that arrive much later (due to their originating off-chip) and hence necessitate the triggering of an urgent and abrupt throughput reduction to prevent a Brownout.

The FLL can reduce (e.g., step-down) its output frequency by a predetermined amount (e.g., percentage). The predetermined amount can be programmable. In response to a step-down command being received by the FLL, internal circuitry of the FLL decreases the output frequency by the programmed amount. Once such a step-down event is completed, the FLL steadily ramps up the frequency to relock to the initial target frequency. To decrease the output frequency, the switching activity in the SoC IP core can be transiently reduced, which in turn reduces the current drawn from the PMIC SMPS. In aspects, the step-down commands or requests can be cascaded to have a compound effect on the output frequency. Using cascaded step-down commands provides a progressive and graceful reduction of the output frequency (and hence circuit switching activity and current draw) to ensure that the PMIC SMPS limits are not breached.

The mitigation techniques described herein use precise, real-time power metrics (e.g., on the order of nanoseconds) from the current sensor to throttle the circuit switching activity of an IP core by modulating the output frequency of the FLL in an expeditious and graceful manner. By triggering the mitigation operation at the precise juncture (using data from the on-die current sensor) and gradually modulating the switching activity of the IP core (by controlling the FLL output frequency via field programmable registers) as necessary, the described mitigation framework ensures minimal degradation in throughput and compliance with switching regulator ratings, resulting in a continuously smooth user experience.

Although the mitigation techniques herein are described with respect to current, these techniques can also be applied for thermal mitigation, such as by using a thermal sensor integrated with the SoC to trigger a gradual and progressive decrease in the frequency with minimal impact on performance and user experience. While features and concepts of the described techniques for peak-current draw mitigation can be implemented in any number of different environments, aspects are described in the context of the following examples.

### Example Systems and Apparatuses

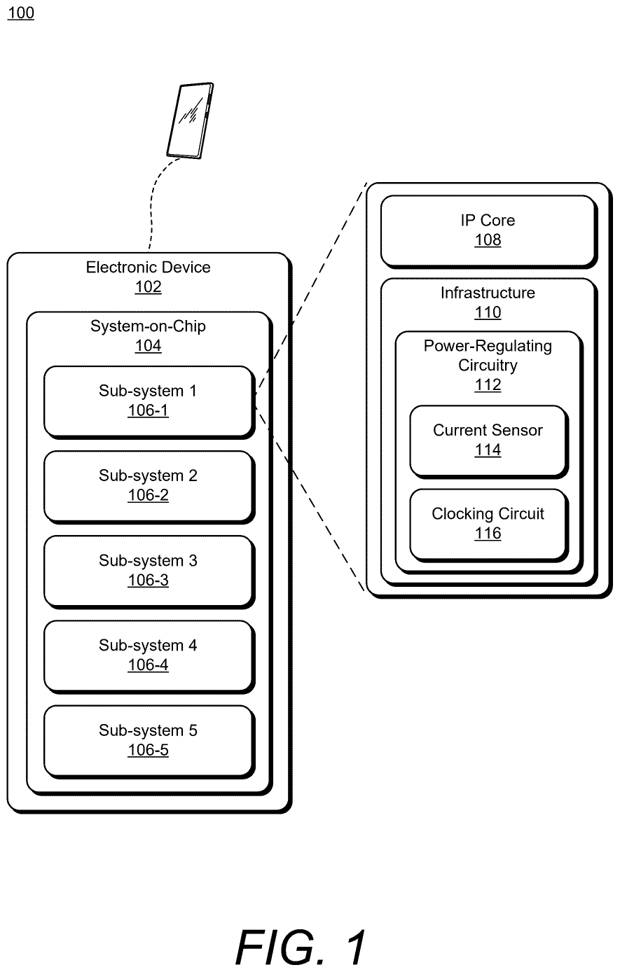

FIG. 1 illustrates an example environment 100 that includes an electronic device 102 in which aspects of peak-current draw mitigation can be implemented. The electronic device 102 is illustrated as including a System-on-Chip (SoC) 104 with a plurality of sub-systems 106 (e.g., sub-system 1 106-1, sub-system 2 108, sub-system 3 106-3, sub-system 4 106-4, and sub-system 5 106-5). The SoC 104 can include more or fewer sub-systems than the illustrated example. Each sub-system 106 includes an IP core (e.g., IP core 108) and infrastructure 110 components. The IP core 108 can be any suitable IP core, such as a graphics processing unit (GPU), a central processing unit (CPU), a tensor processing unit (TPU), a media engine, and the like.

The infrastructure 110 provides communication interfaces, power management functions, clock management functions, and the like. For example, the infrastructure 110 can include power-regulating circuitry 112 for providing and controlling power management functions and clock management functions. The power-regulating circuitry 112 may be, or be part of, an ODPM framework. In aspects, the power-regulating circuitry 112 includes an integrated current sensor 114 and a clocking circuit 116, such as a frequency-locked loop (FLL) circuit. In aspects, there is a separate power-regulating circuitry 112 for each sub-system 106 of the SoC 104, where each separate power-regulating circuitry 112 includes an on-die current sensor (e.g., the current sensor 114) and a particular clocking circuit (e.g., the clocking circuit 116 such as an FLL) for regulating power consumption of a corresponding sub-system, which can draw power from several hundred microwatts (μW) (e.g., 200 μW, 350μW, 500 μW) to a few milliwatts (mW) (e.g., 2 mW, 3 mW, 5 mW, 7 mW, 10 mW). The current sensor 114 and the clocking circuit 116 can be implemented to provide a precise mitigation strategy for current draw with minimal degradation in performance.

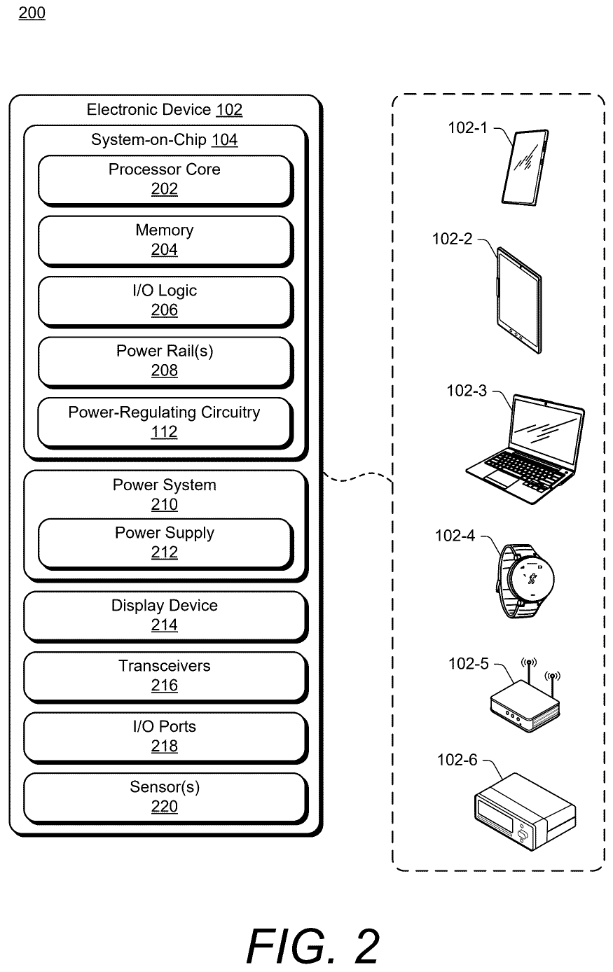

FIG. 2 illustrates an example implementation 200 of the electronic device 102 from FIG. 1 in more detail. The electronic device 102 may include additional components and interfaces omitted from FIG. 1 for the sake of clarity. The electronic device 102 can be a variety of consumer electronic devices (e.g., computer systems). As non-limiting examples, the electronic device 102 can be a mobile phone 102-1, a tablet device 102-2, a laptop computer 102-3, a wearable computing device 102-4, (e.g., smart-watch), a broadband router 102-5 (e.g., mobile hotspot), or automotive computing system 102-6 (e.g., navigation and entertainment system). Although not shown, the electronic device 102 may also be implemented as a mobile station (e.g., fixed-or mobile-STA), a mobile communication device, a client device, a user equipment, an entertainment device, a gaming device, a mobile gaming console, a personal media device, a media playback device, a health monitoring device, a drone, a camera, a wearable smart-device, an Internet home appliance capable of wireless Internet access and browsing, an IoT device, and/or other types of user devices. The electronic device 102 may provide other functions or include components or interfaces omitted from FIG. 2 for the sake of clarity or visual brevity.

As shown in FIG. 2, the SoC 104 includes a processor core 202 and memory 204, which may include computer-readable media, memory media, and/or storage media. The processor core 202 may be implemented as a general-purpose processor core (e.g., of a multicore central-processing unit (CPU) or application processor (AP)), an application-specific integrated circuit (ASIC), graphics processing unit (GPU), or a processor core with other components of the electronic device 102 integrated therewith. The memory 204 can include any suitable type of computer-readable media, memory media, and/or storage media. For example, the memory 204 may include read-only memory (ROM), programmable ROM (PROM), random access memory (RAM), dynamic RAM (DRAM), static RAM (SRAM), or Flash memory. In the context of this disclosure, the memory 204 of the electronic device 102 is implemented as a hardware-based or physical storage device, which does not include transitory signals or carrier waves. Applications, firmware, and/or an operating system (not shown) of the electronic device 102 can be embodied on the memory 204 as processor-executable instructions, which the processor core 202 may execute to provide various functionalities of the electronic device 102. The memory 204 may also store device data, such as user data or user media that is accessible by the applications, firmware, or operating system of the electronic device 102.

In this example, the SoC 104 also includes instances of input/output logic 206 (input/output (I/O) logic 206), one or more power rails 208, and power-regulating circuitry 112. The I/O logic 206 may include circuitry configured to interface control logic of the processor core 202 with various analog and/or digital I/O circuits of the electronic device 102. For example, the I/O logic 206 can enable the processor core 202 or other control logic to interface with sensors, data ports, transceivers, or other components of the electronic device 102. In various implementations, respective circuitry of the processor core 202, memory 204, and I/O logic 206 may operate at different voltages provided by a power system 210 of the electronic device 102 that includes a power supply 212. In some aspects, the power rail 208 of the SoC 104 is coupled to and receives power from the power supply 212. Generally, the SoC 104 may operate from the power provided by the power rail 208. If the current drawn by the processor core 202 breaches a current threshold level, then the power-regulating circuitry 112 reduces the frequency in the clocking circuit 116 (e.g., FLL) in a step-down manner to reduce the current draw with minimal performance degradation.

In aspects, the power system 210 includes one or more power supplies 212, which provide regulated power to the components of the electronic device 102 and/or the SoC 104. In various implementations, an electronic device 102 may include or be configured with a display device 214, transceivers 216, I/O ports 218, and/or sensors 220, which can receive power from the power supply 212 of the power system 210. The power supply 212 of the power system 210 may include any suitable type of power supply, such as linear regulators, switch-mode power supplies (SMPS), multiphase switching regulators, or the like. The power system 210 may receive input power from an external power source (e.g., external AC/DC adapter) or one or more battery cells of a battery or battery pack electrically coupled to the electronic device 102.

The display device 214, transceivers 216, I/O ports 218 and/or sensors 220 of the electronic device 102 may be configured in any suitable fashion and can be operably coupled with the I/O logic 206. For example, the display device 214 may be coupled with the processor core 202 or another processor of the SoC 104 (e.g., graphics processing unit (GPU), not shown) and configured to graphically present an operating system or applications of the electronic device 102. The transceivers 216 enable the electronic device 102 to communicate data (e.g., device data) over wired or wireless networks according to any suitable communication protocol. The I/O ports 218 of the electronic device 102 may include universal serial bus (USB) ports, coaxial cable ports, and other serial or parallel connectors (including internal connectors) useful to couple the user device to various components, peripherals, or accessories (e.g., keyboards, microphones, cameras). Alternatively or additionally, the sensors 220 can enable the electronic device 102 to sense various properties, variances, stimuli, or characteristics of an environment in which the electronic device 102 operates. For example, the sensors 220 may include a motion sensor, an ambient light sensor, an acoustic sensor, a capacitive sensor, an infrared sensor, a temperature sensor, a radar sensor, or a magnetometer.

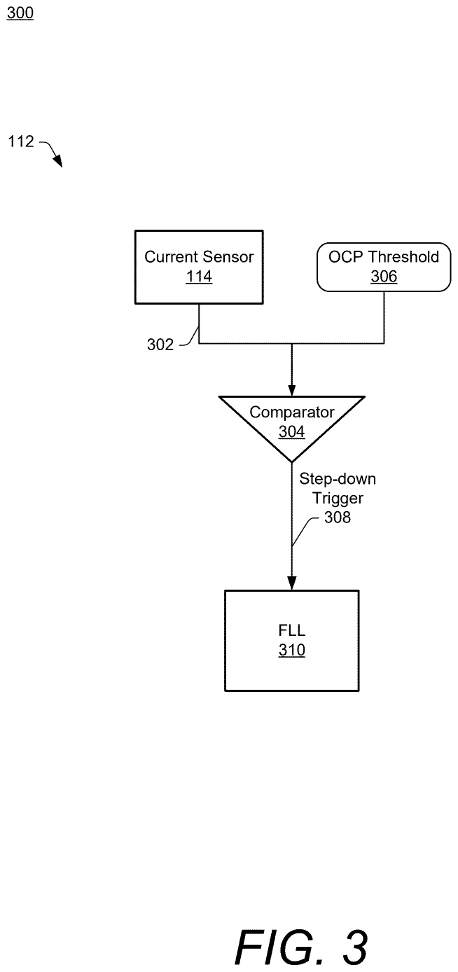

FIG. 3 illustrates an example configuration 300 of the power-regulating circuitry 112 from FIG. 2 in more detail and in accordance with some implementations. The power-regulating circuitry 112 includes the current sensor 114, which measures the current on a power rail (e.g., the power rail 208 from FIG. 2) and provides an output measurement 302 representing the rail current. In an example, the current sensor 114 can provide a current measurement every 500 nanoseconds (ns). A comparator 304 compares the output measurement to a threshold, such as an overcurrent protection (OCP) threshold 306. The OCP threshold 306 defines a level of current used to trigger a safety mechanism to prevent damage caused by excessive current draw, such as short circuits or heavy loads. The power-regulating circuitry 112 can utilize one or more thresholds to trigger mitigation strategies having different levels of severity in order to maintain safe operation of the SoC 104.

If the output measurement 302 (e.g., the rail current measurement) is determined to be greater than the OCP threshold 306, then a step-down trigger 308 (e.g., interrupt signal) is provided to an FLL 310, causing a near-instantaneous, small decrease in clock frequency, which is referred to as an FLL step-down. The FLL is an example of the clocking circuit 116 from FIG. 1. In an example, the FLL step-down is programmed to a small amount, such as 5%, 10%, 12%, etc. In aspects, the step-down is programmed to be 20% or less. By comparison, conventional integer clock dividers implement a 50% minimum frequency throttle. The power-regulating circuitry 112 includes a short latency of several hundred nanoseconds, such as a latency of less than 300 ns (e.g., 250 ns, 225 ns, 200 ns, 180 ns, 150 ns) for the mitigation reaction. Such a short latency is significantly quicker than conventional techniques that use external (e.g., off-die) current sensors and clock dividers, which can have a large delay of several thousand clock cycles, such as a latency of several microseconds (μs).

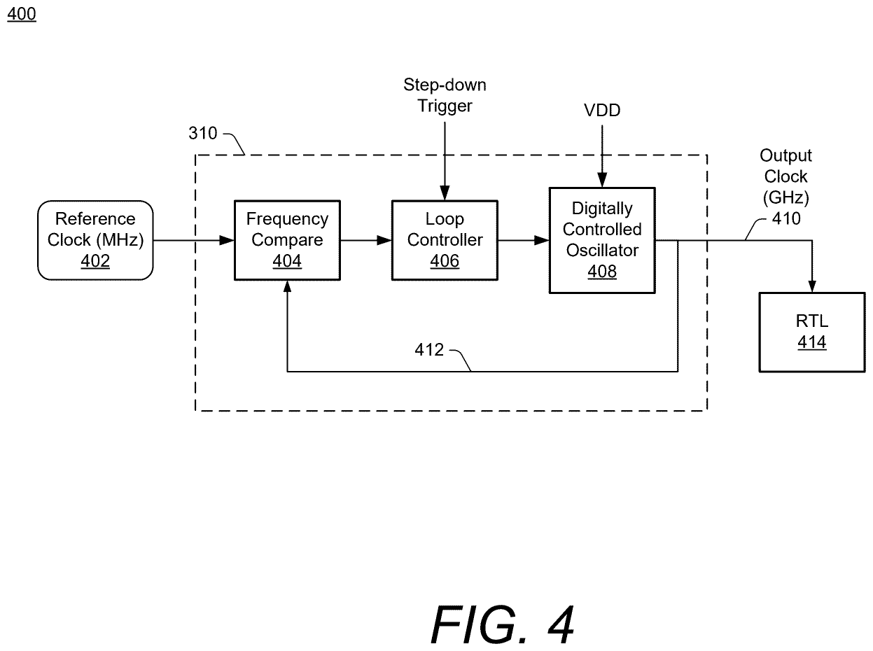

FIG. 4 illustrates an example configuration 400 of the FLL 310 from FIG. 3. The FLL 310 is a feedback loop that ensures that the output frequency substantially equals the desired frequency on average. A reference clock 402 provides a reference frequency for the FLL 310. The FLL 310 includes a frequency compare block 404, a loop controller 406, and a digitally controlled oscillator (DCO) 408. The frequency compare block 404 compares the FLL's current frequency to a multiple (e.g., integer multiple) of the reference frequency of the reference clock 402 and provides a comparison output. For example, the frequency compare block 404 compares K*Freq_ref versus Freq_FLL, where K is a programmable integer, Freq_ref is the reference frequency and Freq_FLL is the output frequency of the FLL 310 (e.g., output frequency of the DCO 408). The loop controller 406 takes the comparison output from frequency compare block 404 and adjusts a digital code that is sent to the DCO 408. The DCO 408 generates an output frequency (e.g., Freq_FLL) for the FLL based on the digital code received from the loop controller 406. The output frequency represents an output clock 410 and may be on the order of gigahertz (GHz).

Further, the output frequency generated by the DCO 408 is provided to both the frequency compare block 404 via a feedback loop 412 and to a register transfer level (RTL) 414 (including a critical path) for operation of the SoC 104 or a sub-system 106 (from FIG. 1) of the SoC 104. The RTL 414 represents an abstraction of the behavior and functionality of a digital circuit or system, such as the SoC 104 or a sub-system of the SoC 104. The feedback loop 412 is used to compare the output frequency of the DCO 408 to a multiple of the reference frequency of the reference clock 402 and then to adjust the digital code for the DCO 408 to match the multiple of the reference frequency. In this way, the FLL 310 is “locked” onto the reference or “target” frequency.

In the case of a step-down, an input (e.g., step-down trigger 308 from FIG. 3 is provided to the loop controller 406. The loop controller 406, in response to receiving the step-down trigger 308, immediately decreases the digital code to be sent to the DCO 408 by a pre-programmed amount (e.g., 5%, 10%, 15%). The feedback loop 412 is still running, however, but at a slower rate (e.g., one microsecond). Accordingly, the FLL 310 continues to compare the output frequency to the reference frequency (or a multiple thereof) and is configured to slowly increase (e.g., ramp up) the digital code until reaching a value that enables the DCO 408 to generate an output frequency that matches the multiple of the reference frequency. In aspects, the FLL 310 output frequency automatically recovers to the target frequency over a duration of time that is inversely proportional to its closed-loop bandwidth. For example, an FLL with a programmed bandwidth of approximately 10 kilohertz (kHz) can return to its programmed frequency over the course of approximately 10 μs. Due to this inherent response by the FLL 310 to steadily ramp up its output frequency toward the multiple of the reference frequency, the mitigation techniques described herein transiently reduce the switching activity of an SoC IP core, which in turn reduces the current drawn from the PMIC SMPS. Further, there may be a series of step-down triggers 308 to reduce the output frequency multiple times in small steps and consequently reduce the current draw of the SoC IP core in order to prevent damage caused by excessive current draw.

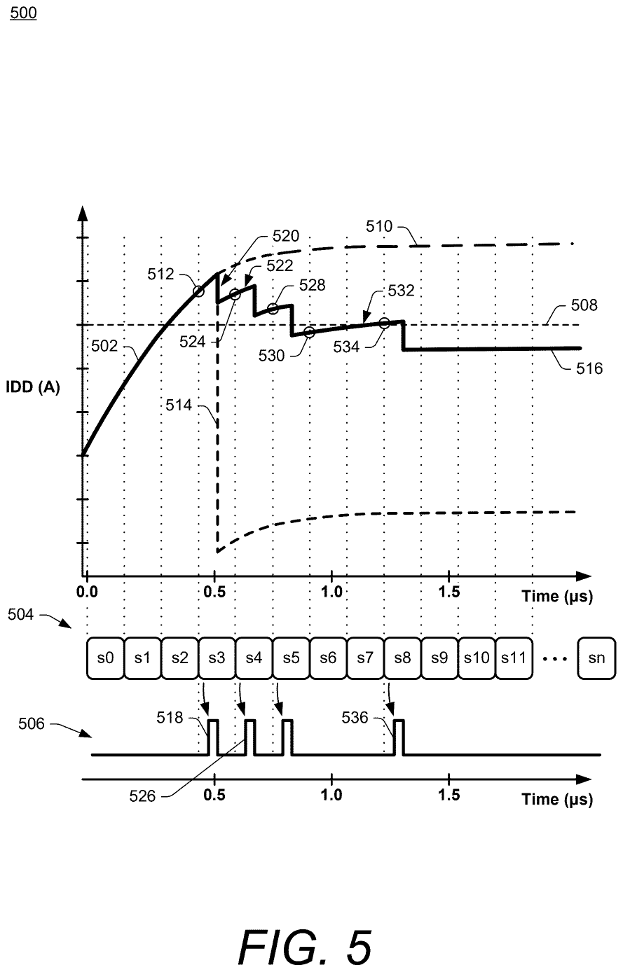

FIG. 5 illustrates an example implementation 500 of peak-current mitigation techniques described herein in comparison to conventional mitigation techniques (e.g., clock divider). In the example implementation 500, electric current draw (IDD) of an SoC IP core (e.g., IP core 108) is plotted against time (μs). Current 502 drawn by the IP core is sampled by the current sensor (e.g., the current sensor 114) at regular intervals to generate current measurements 504 (e.g., s0, s1, s2, ..., sn). Plot 506 represents FLL step-down triggers implemented using the mitigation techniques described herein.

In the illustrated example, the current 502 rises exponentially and approaches a threshold 508 (e.g., OCP threshold 306). The threshold 508 represents the limit of safe sustained current draw for the IP core, such as a maximum current (e.g., Iₘₐₓ). An unmitigated response (dashed line 510) to sustained current above the maximum current (e.g., the threshold 508) can result in damage caused by excessive current draw. Conventional systems use a clock divider to severely reduce the current in a single step. For example, after measuring the current 502 at sample 512 and determining that the current 502 at sample 512 is above the threshold 508, the conventional integer clock divider drops the current (represented by dashed line 514) from being above the threshold 508 down to a significantly lower current such as, for example, less than 10 amps (A). Such a significant decrease in the current, however, results in a perceivable and visible degradation in performance and, consequently, a poor user experience.

In contrast to the conventional systems, when a step-down trigger is created for the FLL, the FLL reduces an accumulator value by a programmable fraction. This has an immediate (after a clock domain crossing (CDC) synchronization (e.g., transferring a signal from one clock domain to another clock domain)) and glitch-free impact on the DCO frequency, causing the DCO to decrease the frequency by approximately the same amount. After the step-down event, the FLL relocks to the target frequency according to its normal behavior. This frequency step-down is illustrated by solid line 516.

For example and as illustrated in FIG. 5, in response to determining that the current 502 at sample 512 is above the threshold 508, a step-down trigger is sent to the FLL, which immediately creates an interrupt 518 to decrease its output frequency by a small programmable amount. In aspects, there may be a small latency associated with the time for the FLL to process and apply the step-down, such as approximately 250 nanoseconds. In the illustrated example, the output frequency is reduced by about 5%, which correspondingly reduces the current 502 by a similar amount, as shown at 520. Then, based on the inherent characteristics of the FLL, the FLL slowly increases its output frequency toward its original target (e.g., the reference frequency). Accordingly, the current 502 slowly rises, as shown at 522. At sample 524, the current 502 is determined to still exceed the threshold 508 and in response, a new step-down trigger 526 is generated for the FLL to again reduce its output frequency by the programmable amount. This process is repeated based on sample 528 because the current 502 still exceeds the threshold 508, resulting in the current 502 dropping below the threshold 508. In this way, the step-down triggers (e.g., requests) are cascaded to have a compound effect on the output frequency, as shown in the illustrated example. This enables a progressive and graceful reduction in the output frequency (and hence circuit switching activity and current draw) to ensure that PMIC SMPS limits are not breached.

Sample 530 is determined to be below the threshold 508 and thus, no step-down trigger is generated for the FLL. However, as the FLL steadily ramps up its output frequency to relock to the initial reference frequency, the current 502 rises, as shown at 532, and at sample 534, it is determined that the current 502 again exceeds the threshold 508. Accordingly, another step-down trigger 536 is generated and the FLL reduces its output frequency by the programmable amount, which reduces the current 502 to below the threshold 508. In this way, the current 502 is reduced in small amounts so as to have minimal impact on performance degradation and little to no perceivable change to the user experience.

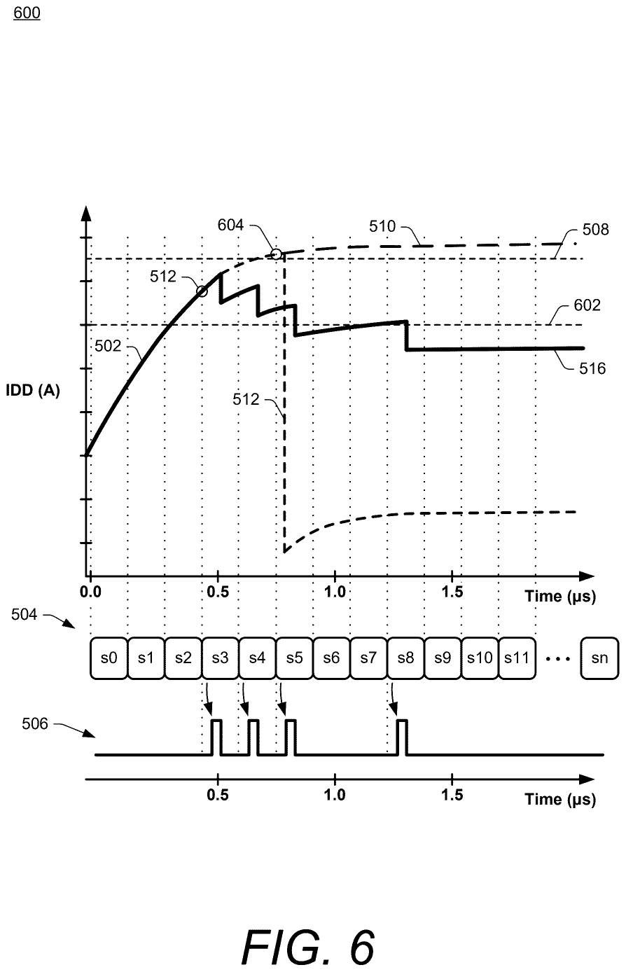

FIG. 6 illustrates another example implementation 600 of peak-current mitigation techniques described herein in comparison to conventional mitigation techniques (e.g., clock divider). In FIG. 6, multiple thresholds are used for the peak-current mitigation. For example, the threshold 508 can be used as a “hard” threshold (e.g., upper limit) to trigger more severe mitigation strategies. One or more additional current thresholds can be used as “soft” current thresholds to trigger less severe mitigation strategies that can minimize the perceivable impact in the user experience.

For example, soft threshold 602 can be used to trigger a cascading step-down process similar to that described with respect to FIG. 5. In this way, the current 502 can be transiently mitigated over a series of cascading FLL step-downs prior to breaching the hard threshold (e.g., threshold 508), as shown by the solid line 516. In conventional techniques that use the integer clock divider (see dashed line 514) and the threshold 508 as the only threshold, the conventional mitigation response is not implemented until after sample 604 (e.g., at s5) measures the current to exceed the threshold 508. Here, however, the soft threshold 602 along with the cascading step-down process enable the current 502 to be gradually and gracefully reduced, beginning at an earlier point in time (e.g., at s3) and without breaching the peak current limit of the SMPS.

Although the example shown in FIG. 6 is implemented with two thresholds, Any suitable number of thresholds can be used. In addition, different preprogrammed amounts or percentages can be employed for the FLL step-down.

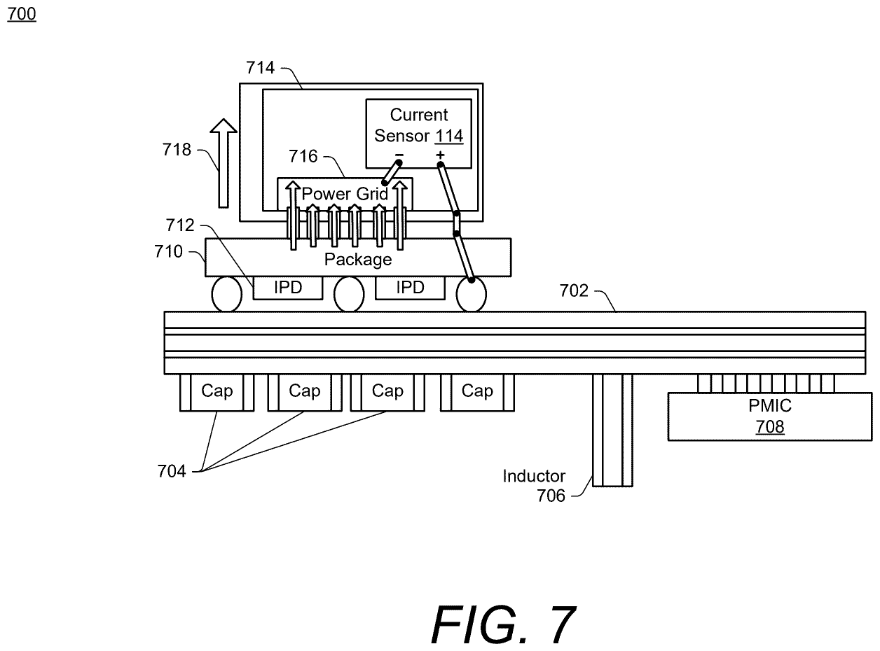

FIG. 7 illustrates a block diagram 700 of an example SoC stack in accordance with some implementations. The example SoC stack may be an example of the SoC 104 in FIG. 1. The illustrated example includes a printed circuit board (PCB) 702 with various capacitors 704, one or more inductors 706, and a PMIC 708 electrically coupled to the PCB Q. A package 710, with power switches (e.g., intelligent power devices (IPD) 712) is mounted on the PCB 702 and coupled to a processor unit 714, such as TPU, CPU, GPU, etc. The processor unit 714 includes a power grid 716 and an on-die current sensor (e.g., the current sensor 114) for measuring current 718 draw by the processor unit 714. In implementations, each IP core rail can include its own current sensor.

The current sensor 114 can provide an estimate of the power consumption of the rail that the current sensor 114 is configured to sense. For example, the current sensor 114 can digitize a voltage drop across an impedance of the package 710 of a power distribution network (PDN). Because the voltage drop across the PDN is linearly related to direct current (DC) and IR drop (referring to voltage drop based on voltage (V)=current (I)*resistance (R)), the output codes from the current sensor 114 are directly correlated to the total power consumption of the processor unit 714.

The readout of the current sensor 114 is variable and can be controlled to trade off speed with respect to accuracy (e.g., a high-speed mode versus a high-accuracy mode). For example, the current sensor 114 has a highly reconfigurable sensor speed from Megahertz (MHz) to kHz with optimal resolution for thresholding and detection to achieve the best closed-loop power performance. Comparatively, the high-accuracy mode provides a higher resolution with lower speed, whereas the high-speed mode provides a lower resolution with a higher speed. In the high-speed mode, the current sensor 114 can provide data at a MHz speed with a first resolution. The accuracy of the sensor may depend on a spatial sampling error of the PDN and can be controlled by calibrating or thresholding. By comparison, in the high-accuracy mode the current sensor 114 can average its output samples digitally, reducing the noisiness of the sampled data to improve its resolution to a second, higher resolution, but drops its readout speed to a kHz speed. This high-accuracy mode can be useful for long-term current monitoring where the resolution is critical for fine-grained estimation of the system current.

### Example Methods

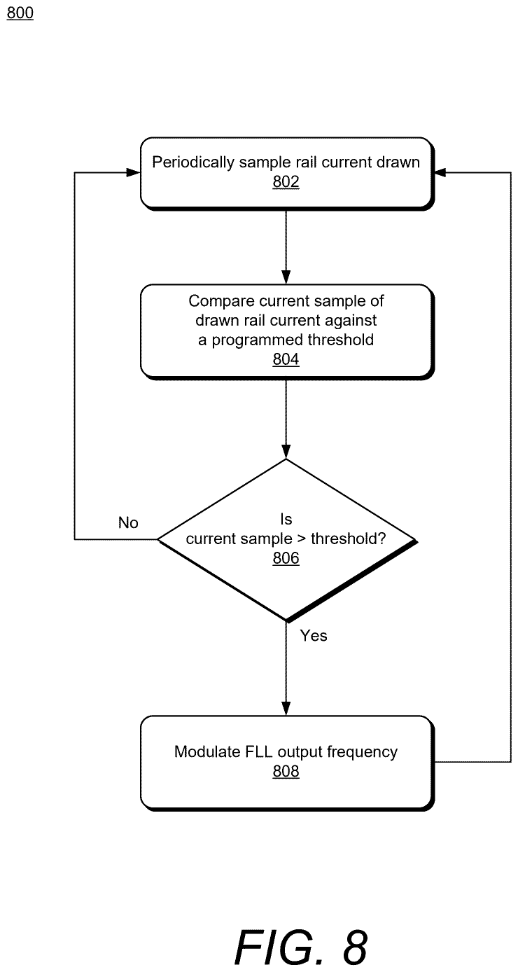

FIG. 8 depicts a method 800 for implementing peak-current draw mitigation. The method 800 can be performed by the SoC 104 of the electronic device 102. The method 800 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example electronic device 102 of FIG. 1 or to entities or processes as detailed in FIGS. 2-7, reference to which is made for example only. The techniques are not limited to performance by one entity or multiple entities operating on one device.

At 802, a current sensor periodically samples rail current drawn by an SoC IP core. For example, the current sensor 114, which is an on-die sensor, monitors the rail current drawn by the IP core 108.

At 804, a current sample of the rail current is compared against a programmed threshold. For example, the comparator 304 compares the output measurement 302 of the current sensor 114 against the threshold 508 or the soft threshold 602.

At 806, if the current sample of the rail current is less than the threshold (e.g., “NO” at 806), then the method 800 returns to 802 to collect a new sample of the rail current. If, however, the current sample of the rail current is equal to or greater than the threshold (e.g., “YES” at 806), then the method 800 proceeds to 808 where an FLL output frequency is modulated. In aspects, modulating the FLL output frequency decreases the FLL output frequency by a predetermined and programmable amount (e.g., percentage), which reduces the rail current being drawn. In an example, the FLL output frequency is modulated by providing a step-down command (e.g., step-down trigger 308) to the FLL 310, which causes the loop controller 406 of the FLL 310 to adjust the digital code provided to the DCO 408 for generating the FLL output frequency.

After modulating the FLL output frequency, the method 800 loops back to 802 to collect another sample to continue periodically monitoring the rail current. Accordingly, the method 800 can apply a series of modulations to the FLL output frequency to incrementally decrease the current draw in small amounts (e.g., less than 20%) to minimize the impact on performance.

### Example Systems

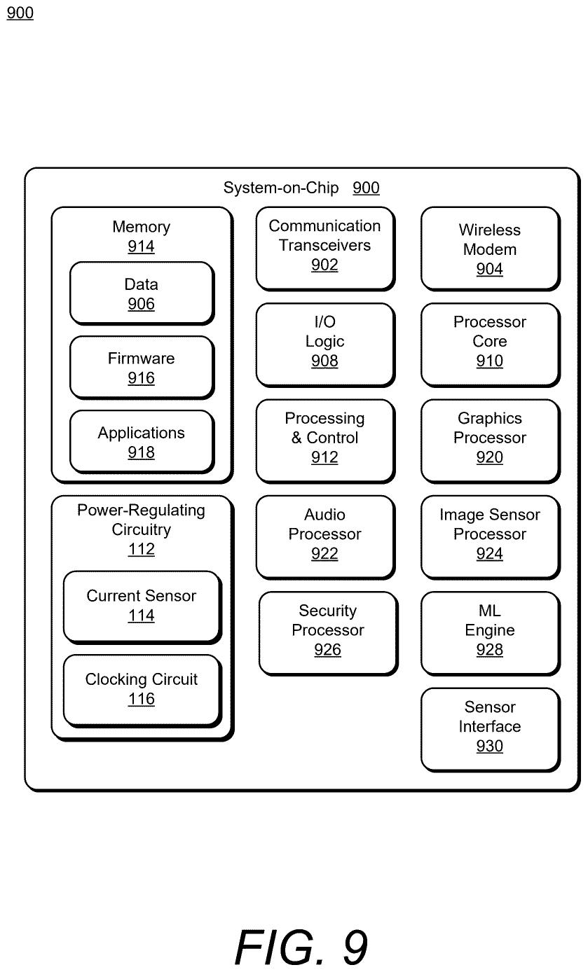

FIG. 9 illustrates an example system-on-chip (SoC) in which aspects of peak-current draw mitigation can be implemented. In aspects, the SoC 900 may represent similar or alternate configurations of the SoC 104 as described with reference to FIG. 1. Accordingly, the SoC 900 may be embodied as or within any type of electronic device 102, user equipment, apparatus, other device, or system as described with reference to FIGS. 1-8. Although described with reference to chip-based packaging, the components shown in FIG. 9 may be embodied as other systems or component configurations, such as, and without limitation, a power management integrated-circuit (PMIC), a power regulation circuit, a low-dropout (LDO) integrated-circuit, a Field-Programmable Gate Array (FPGA), an Application-Specific Integrated Circuit (ASIC), an Application-Specific Standard Product (ASSP), a digital signal processor (DSP), Complex Programmable Logic Devices (CPLD), system in package (SiP), package on package (PoP), a graphics processing unit (GPU), a machine-learning engine, processing and communication chip set, communication co-processor, sensor co-processor, or the like.

In this example, the SoC 900 includes communication transceivers 902 and a wireless modem 904 that enable wired or wireless communication of data 906 (e.g., received data, data that is being received, data scheduled for broadcast, packetized, and the like). In some aspects, the wireless modem 904 is implemented as a multi-mode multi-band modem or baseband processor that is configurable to communicate in accordance with various communication protocols and/or in different frequency bands. The wireless modem 904 may include a transceiver interface (not shown) for communicating encoded or modulated signals with transceiver circuitry, and/or controlling a radio frequency (RF) front end.

The data 906 or other system content can include configuration settings of the system or various components, media content stored by the system, and/or information associated with a user of the system. Media content stored on the SoC 900 may include any type of audio, video, and/or image data. The SoC 900 also includes an instance of I/O logic 908, which may be configured similar to I/O logic 206 as described throughout this disclosure. In some implementations, the I/O logic 908 of the SoC 900 is configured as one or more data inputs via which any type of data, media content, and/or inputs can be received, such as user input, user-selectable inputs (explicit or implicit), or any other type of audio, video, and/or image data received from a content and/or data source. Alternatively or additionally, the I/O logic 908 may include various data interfaces, which can be implemented as any one or more of a serial and/or parallel interface, a wireless interface, a network interface, and as any other type of communication interface enabling communication with other devices or systems.

The SoC 900 includes one or more processor cores 910 (e.g., IP core 108), which process various computer-executable instructions to control the operation of the SoC 900 and to enable any suitable functionalities of the SoC 900. Alternatively or additionally, the SoC 900 can be implemented with any one or combination of hardware, firmware, or fixed logic circuitry that is implemented in connection with processing and control circuits, which are generally shown at 912. Although not shown, the SoC 900 may also include a bus, interconnect, crossbar, or fabric that couples the various components within the system.

The SoC 900 also includes a memory 914 (e.g., computer-readable media), such as one or more memory circuits that enable persistent and/or non-transitory data storage, and thus do not include transitory signals or carrier waves. Examples of the memory 914 include ROM, RAM, DRAM, SRAM, or Flash memory. The memory 914 provides data storage for the system data 906, as well as for firmware 916, applications 918, and any other types of information and/or data related to operational aspects of the SoC 900. For example, the firmware 916 can be maintained as processor-executable instructions of an operating system (e.g., real-time operating system) within the memory 914 and executed on one or more of the processor cores 910.

The applications 918 may include a system manager, such as any form of a control application, software application, signal-processing and control module, code that is native to a particular system, an abstraction module, a machine learning module, or gesture module and so on. The memory 914 may also store system components or utilities for implementing any suitable functionalities of the SoC 900. In some aspects, the SoC 900 also includes additional processors or co-processors to enable other functionalities, such as a graphics processor 920, audio processor 922, and image sensor processor 924. The graphics processor 920 may render graphical content associated with a user interface, operating system, or applications of the SoC 900. In some cases, the audio processor 922 encodes or decodes audio data and signals, such as audio signals and information associated with voice calls or encoded audio data for playback. The image sensor processor 924 may be coupled to an image sensor and provide image data processing, video capture, and other visual media conditioning and processing functions.

In aspects, the SoC 900 includes power-regulating circuitry 112, current sensor(s) 114, and/or clocking circuit(s) 116, which may be implemented as described with reference to FIGS. 1-9. In some cases, the I/O logic 908 of the SoC 900 is operably coupled with a voltage rail that provides power to the power-regulating circuitry 112. Alternatively or additionally, the processor cores 910 or other lower-voltage circuitry of the SoC 900 can be coupled to an output node or rail of the power-regulating circuitry 112. In various aspects, the power-regulating circuitry 112 includes the current sensor 114 and the clocking circuit 116 (e.g., FLL 310) as described herein to prevent IP cores of the SoC 900 from exceeding rated operational limits.

The SoC 900 may also include a security processor 926 to support various security, encryption, and cryptographic operations, such as to provide secure communication protocols and encrypted data storage. Although not shown, the security processor 926 may include one or more cryptographic engines, cipher libraries, hashing modules, or random number generators to support encryption and cryptographic processing of information or communications of the SoC 900. Alternatively or additionally, the SoC 900 can include an ML engine 928 and/or a sensor interface 930. Generally, the ML engine 928 may include one or more ML models, artificial intelligence (AI) models, or deep neural networks (DNNs) and a processor core for executing the models and/or networks. The sensor interface 930 can enable the SoC 900 to receive data from various sensors, such as capacitance and motion sensors of a user device in which the system-on-chip is embodied.

### Conclusion

Although aspects of peak-current draw mitigation have been described in language specific to features and/or methods, the subject of the appended claims is not necessarily limited to the specific features or methods described. Rather, the specific features and methods are disclosed as example implementations of the techniques, and other equivalent features and methods are intended to be within the scope of the appended claims. Further, various aspects are described, and it is to be appreciated that each described aspect can be implemented independently or in connection with one or more other described aspects.

What is claimed is:

1. A system-on-chip for mitigating peak-current draw, the system-on-chip comprising:
a sub-system having an intellectual property (IP) core; and
power-regulating circuitry integrated with the sub-system, the power-regulating circuitry comprising:
a frequency-locked loop (FLL) configured to:
generate an output frequency; and
automatically adjust the output frequency over a duration of time to recover the output frequency to a multiple of a reference frequency; and
a current sensor configured to periodically sample a rail current drawn by the IP core, the power-regulating circuitry configured to generate, in response to a current sample of the rail current exceeding a current threshold, a step-down trigger configured to cause the FLL to modulate the output frequency by a predetermined amount to reduce the rail current drawn by the IP core.

2. The system-on-chip of claim 1, wherein the current threshold is an overcurrent protection threshold that defines a level of current used to initiate the power-regulating circuitry for mitigating the peak-current draw.

3. The system-on-chip of claim 1, wherein the current threshold is lower than an overcurrent protection threshold that defines a rated limit of current draw for the IP core, and wherein the power-regulating circuitry is configured to generate the step-down trigger for each sample that exceeds the current threshold.

4. The system-on-chip of claim 1, wherein the predetermined amount is 20 percent or less of the output frequency.

5. The system-on-chip of claim 1, wherein the power-regulating circuitry is configured to generate cascading step-down triggers to progressively reduce the output frequency of the FLL.

6. The system-on-chip of claim 1, wherein:
the FLL includes:
a frequency compare block configured to compare the output frequency to the multiple of the reference frequency;
a loop controller configured to generate digital code used to generate the output frequency; and
a digitally controlled oscillator configured to generate the output frequency based on the digital code received from the loop controller; and
a feedback loop from the output frequency of the digitally controlled oscillator to the frequency compare block.

7. The system-on-chip of claim 6, wherein the step-down trigger causes the loop controller to decrease the digital code generated for the digitally controlled oscillator by a pre-programmed amount.

8. The system-on-chip of claim 6, wherein the duration of time for the FLL to recover the output frequency to the multiple of the reference frequency is inversely proportional to a bandwidth of the feedback loop.

9. The system-on-chip of claim 1, wherein the current sensor is an on-die current sensor that is directly integrated onto a silicon die of the sub-system.

10. The system-on-chip of claim 1, further comprising:
a plurality of sub-systems including the sub-system; and
a separate power-regulating circuitry for each sub-system of the plurality of sub-systems, each separate power-regulating circuitry having an on-die current sensor and a particular frequency-locked loop for regulating power consumption of a corresponding sub-system.

11. A method for peak-current mitigation, the method comprising:
periodically sampling, using an on-die current sensor, a rail current drawn by an intellectual property (IP) core of a sub-system of a system-on-chip;
comparing a current sample of the rail current against a programmed threshold;
determining whether the current sample of the rail current exceeds the programmed threshold; and
in response to a determination that the current sample of the rail current exceeds the programmed threshold, modulating an output frequency of a frequency-locked loop (FLL) to decrease the rail current drawn by the IP core.

12. The method of claim 11, wherein modulating the output frequency of the FLL includes:
generating a step-down trigger for the FLL; and
providing the step-down trigger to the FLL to cause the FLL to modulate the output frequency.

13. The method of claim 12, wherein the step-down trigger is configured to cause the FLL to decrease the output frequency by 20 percent or less of the output frequency.

14. The method of claim 12, wherein modulating the output frequency of the FLL further includes:
generating digital code for a digitally controlled oscillator that generates the output frequency;
adjusting the digital code based on the step-down trigger; and
reducing the output frequency based on the adjusted digital code.

15. The method of claim 14, further comprising automatically recovering the output frequency to a multiple of a reference frequency based on a feedback loop in the FLL.

16. The method of claim 15, wherein the automatically recovering the output frequency to the multiple of the reference frequency occurs over a duration of time that is inversely proportional to a bandwidth of the feedback loop.

17. The method of claim 15, wherein the output frequency is incrementally decreased based on a series of step-down triggers generated for each of a series of current samples that exceed the programmed threshold.

18. The method of claim 15, wherein the periodically sampling the rail current is performed on the order on nanoseconds and the automatically recovering the output frequency to the multiple of the reference frequency is performed on the order of microseconds.

19. The method of claim 11, wherein the on-die current sensor is directly integrated onto a silicon die of the sub-system.

20. The method of claim 11, wherein the programmed threshold is lower than an overcurrent protection threshold that defines a rated limit of current draw for the IP core, and wherein a new step-down trigger is generated for each sample that exceeds the programmed threshold.
